(19) United States
(12) Patent Application Publication
(10) Pub. No.: US 2026/0184836 A1
(43) Pub. Date: Jul. 2, 2026

(54) HEXAFLUORO-ISO-PROPYLIDENE ENCHAINED AROMATIC POLYMERS AND METHODS FOR PREPARATION THEREOF

(71) Applicant: Mississippi State University, Starkville, MS (US)

(72) Inventors: Dennis W. Smith, Braselton, GA (US); Gustavo Adolfo Munoz, Starkville, MS (US)

(21) Appl. No.: 19/435,897

(22) Filed: Dec. 30, 2025

Related U.S. Application Data
(60) Provisional application No. 63/740,094, filed on Dec. 30, 2024.

(51) Int. Cl. C08G 10/00

(52) U.S. Cl. CPC C08G 10/00

(57) ABSTRACT

Methods of making a polymer having main chain 1,1,1,3,3,3-hexafluoroisopropylidene (6F) linkages are described herein. The method can include contacting hexafluoroacetone hydrate and a first aromatic monomer in the presence of an acid to provide the polymer, wherein the first aromatic monomer has a structure as defined herein. Polymers having main chain 1,1,1,3,3,3-hexafluoroisopropylidene (6F) linkages are also disclosed.

### CROSS REFERENCE TO RELATED APPLICATION

This application claims priority to U.S. Provisional Application No. 63/740,094, filed on Dec. 30, 2024, the contents of which are hereby incorporated by reference in their entirety.

### FIELD OF THE INVENTION

The present disclosure is directed to a synthetic method for preparing semi-fluorinated aromatic polymers containing a hexafluoroisopropylidene (6F) group, and semi-fluorinated aromatic polymers containing the 6F group.

### BACKGROUND

Friedel-Crafts acylation can be used to synthesize semi-crystalline polymers with high thermal stability and good mechanical properties. The aluminum chloride catalyzed acylation of diphenyl ether with mixtures of isophthaloyl chloride (IPC) and terephthaloyl (TPC) chloride has been used to produce poly(ether ketone ketone) (PEKK), a group high-performance materials known under the trade name of Kepstan™, with melting points (Tm) ranging between 373 and 410° C. depending on the IPC/TPC ratio. Friedel-Crafts alkylation has also been used to obtain a variety of aromatic microporous and hyper-crosslinked polymers (HCPs). The mechanochemical polymerization of 1,3,5-triphenylbenzene with dichloromethane and chloroform was reported recently, demonstrating a solvent-free Friedel-Crafts alkylation. HCPs are high surface area materials for potential gas adsorption applications, heterogenous catalysis, and removal of organic pollutants, among others.

Aldehydes and ketones have also been electrophilically polymerized to produce high-performance materials. Hydroxyalkylation polymerizations of electron-rich monomers like p-dimethoxybenzene with benzaldehyde derivatives afforded linear multisegmented block copolymers. Furthermore, Zolotukhin and co-workers reacted the aromatic monomers biphenyl, p-terphenyl, p-quaterphenyl, and 4,4′-diphenoxybenzophenone with semi-fluorinated ketones 1,1,1-trifluroacetone, 2,2,2-trifluroacetophenone, and octafluoroacetophenone to produce semi-fluorinated polymers with excellent thermal properties. An ultra-high molecular weight polymer was obtained by this same group using Friedel-Crafts condensation of isatin (2,3-indolinedione) and biphenyl (see, e.g., A. R. Cruz, M. C. G. Hernandez, M. T. Guzmán-Gutiérrez, M. G. Zolotukhin, S. Fomine, S. L. Morales, H. Kricheldorf, E. S. Wilks, J. Cárdenas, M. Salmón, Precision synthesis of narrow polydispersity, ultrahigh molecular weight linear aromatic polymers by A2+B2 nonstoichiometric step-selective polymerization, Macromolecules. 45 (2012) 6774-6780).

There remains a continuing need in the art for improved methods for incorporation of hexafluoroisopropylidene (6F) groups within the main chain of high performance polymers.

### SUMMARY

In an embodiment, a series of semi-fluorinated polymers were obtained by Friedel-Crafts polymerization of hexafluoroacetone trihydrate (HFAH) with a variety of activated and non-activated aromatic monomers. Interfacial (water/dichloroethane) electrophilic aromatic substitution (EAS) polymerizations were carried out with trifluoromethanesulfonic anhydride (Tf₂O) and a phase transfer catalyst.

The versatile and straightforward method of the present disclosure achieves the synthesis of moderate to high molecular weight (12.0-29.6 kiloDaltons (kDa)) polyaryl ethers and polyphenylenes with 1,1,1,3,3,3-hexafluoroisopropylene (6F) main chain linkages. Predominantly amorphous film-forming materials were obtained with low branching, high solubilities in common organic solvents, thermo-oxidative stabilities up to 500° C., and glass transitions (T_{g}) ranging from 157-250° C. The optical and dielectric properties of these materials were also studied wherefrom high visible region transmittance and low dielectric constant values comparable with commercial materials were found.

One embodiment is a composition of matter on linear homopolymers comprising the 6F group and aromatic groups, for example from monomers such as dibenzofuran, 1,4-diphenoxybenzene, and 1,3-bis(3-phenoxyphenoxy)benzene, monomers biphenyl, fluorene, and terphenyl.

Another embodiment is a polymerization method using HFAH and various aryl (Ar) monomers to form 6F polymers.

### BRIEF DESCRIPTION OF THE FIGURES

FIG. 1A shows strategies to install the 6F group in polymer backbones using reactions of 6F-containing monomer.

FIG. 1B shows strategies to install the 6F group in polymer backbones using direct electrophilic condensation of hexafluoroacetone trihydrate.

FIG. 2 shows a proposed mechanism for step-growth interfacial EAS condensation polymerization.

FIG. 3 shows the general interfacial EAS polymerzation and activated and non-activated aromatic monomers (M1-M6) used with hexafluoroacetone trihydrate.

FIG. 4 shows heteronuclear multiple bond corralation (HMBC) specturm of P5 in deuterated chloroform (CDCl₃).

FIG. 5 shows random copolymerization of diphenyl ether (DPE) and biphenyl (M4) with hexafluoroacetone trihydrate (HFAH).

FIG. 6 shows 19F nuclear magnetic resonance (NMR) at 470 MHz in CDCl₃ of P7 after copolymerization for 24 hours at 60° C.

FIG. 7 shows triblock copolymerization of diphenyl ether (DPE) and biphenyl (M4) with hexafluoroacetone trihydrate (HFAH).

FIG. 8 shows 19F NMR at 470 MHz in CDCl₃ of triblock copolymer P8 after 24 hours at 60° C.

FIG. 9A shows reproducible T_{g} (fourth heating cycle) by differential scanning calorimetry (DSC) analysis in nitrogen (10° C./min) for polyaryl ethers P1-P3 according to various examples of the present disclosure.

FIG. 9B shows reproducible T_{g} (fourth heating cycle) by DSC analysis in nitrogen (10° C./min) for polyphenylenes P4-P6 according to various examples of the present disclosure.

FIG. 10A shows thermogravimetric analysis (TGA) in nitrogen (10° C./min) of polyaryl ethers P1-P3 according to various examples of the present disclosure.

FIG. 10B shows TGA analysis in nitrogen (10° C./min) of polyphenylenes P4-P6 according to various examples of the present disclosure.

FIG. 11 shows transmittance of films P1-P7 according to various examples of the present disclosure.

### DETAILED DESCRIPTION

Polymers containing main chain 1,1,1,3,3,3-hexafluoroisopropylidene (6F) linkage have been studied, and 6F group incorporation is the most common strategy for accessing semi-fluorinated aromatic polymers. 6F-containing polymers present unique characteristics associated with the strong C—F bond and free volume that this group introduces. In most cases the 6F group induced increases in thermal stability, glass transition temperature (T_{g}), solubility, and optical transparency, while decreasing the crystallinity and dielectric constant. Anomalous crystallinity has been observed in some polymers with 6F linkages, including perfluorocyclobutyl (PFCB) polyaryl ether, perfluoropolyethers (PFPE), and semi-fluorinated polyaryl ethers (PAE). Despite a long history of mysterious behavior, the growing list of examples confirm that 6F group incorporation offers a promising route to produce high-performance polymeric materials capable of withstanding the high temperatures and harsh chemical conditions needed for applications in extreme environments, such as the automotive, aerospace, and fuel cell industries. The enhanced free volume and higher T_{g} associated with 6F polymers make them particularly appealing for gas separation technologies.

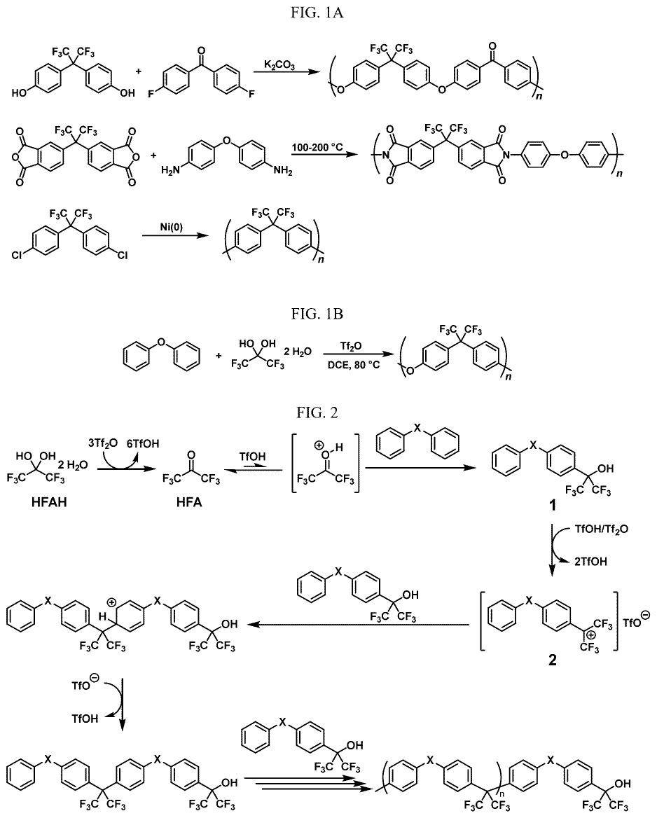

Two main strategies have been used to install the 6F group in aromatic polymers: (1) polymerizing monomers already containing the 6F group or (2) direct electrophilic condensation of hexafluoroacetone with arenes. Known reactions of 6F-contaning monomers (FIG. 1a) include nucleophilic aromatic substitution (SNAr), condensation of dianhydrides with diamines, and carbon-carbon coupling reactions. The direct electrophilic aromatic substitution (EAS) with hexafluoroacetone (FIG. 1b) has been mostly neglected since DuPont's 1966 U.S. Pat. No. 3,291,777 reported the direct polymerization of hexafluoroacetone with diphenyl ether under very harsh conditions (HF/BF₃ at 170° C.) to produce an insoluble material. After lying dormant for more than half a century, the present inventors were inspired to probe for alternative routes from HFA with milder conditions while yielding a processable material.

Surprisingly, the present inventors discovered the mild and versatile interfacial Friedel-Crafts polymerization of diphenyl ether with hexafluoroacetone trihydrate (HFAH) affording linear, soluble, high molecular weight, and semi-crystalline thermoplastic 6F-polyaryl ether (FIG. 1b). In contrast to the crosslinked material reported by DuPont, this version of the 6F-PAE formed an optically clear film from solution and exhibited thermo-oxidative stability up to 535° C., a T_{g} of 160 to 165° C. (e.g., about 163° C.), and low dielectric constant.

The present disclosure is directed to direct interfacial electrophilic condensation polymerization of hexafluoroacetone trihydrate (HFAH) with the activated aromatic oxygen-containing monomers such as dibenzofuran (M1), 1,4-diphenoxybenzene (M2), and 1,3-bis(3-phenoxyphenoxy)benzene (M3). Sulfur- and nitrogen-containing monomers, such as diphenyl sulfide and carbazole, respectively, have also been successfully polymerized with HFAH. Polymerization of non-activated aromatics was also demonstrated using biphenyl (M4), fluorene (M5), and p-terphenyl (M6) as exemplary monomers. In addition, random and segmented copolymers were demonstrated, for example using copolymerization of diphenyl ether and biphenyl was successfully achieved using the same EAS methodology. This series of semi-fluorinated homopolymers and copolymers were formed in moderate to high yields and their thermal and optical properties were obtained. A significant improvement is therefore provided by the present disclosure.

Accordingly, an aspect of the present disclosure is a method of making a polymer comprising main chain 1,1,1,3,3,3-hexafluoroisopropylidene (6F) linkages. The method comprises a direct interfacial electrophilic condensation polymerization of hexafluoroacetone (HFAH) and various aromatic monomers, including dibenzofuran, 1,4-diphenoxybenzene, and 1,3-bis(3-phenoxyphenoxy)benzene, biphenyl, fluorene, and p-terphenyl. The method thus comprises contacting hexafluoroacetone hydrate and a first aromatic monomer in the presence of an acid to provide the polymer, wherein the first aromatic monomer has the structure

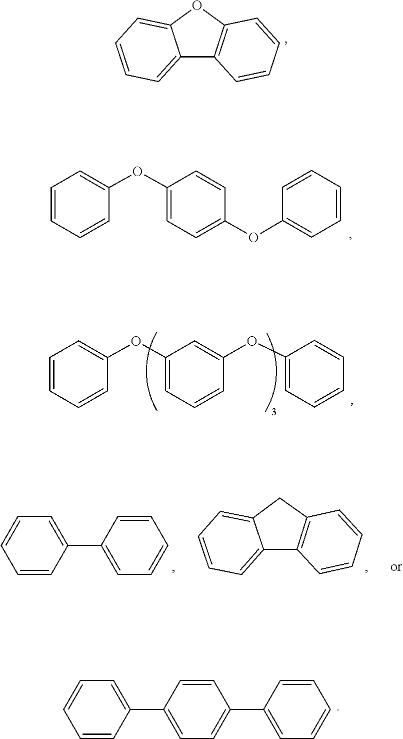

The method can be conducted under conditions effective to provide the polymer. Suitable polymerization conditions are further described in the working examples provided herein. For example, the interfacial polymerization can be conducted at a temperature of 40 to 70° C., or 50 to 65° C., and for a time of 24 hours or less. In an aspect, the molar ratio of the aromatic monomer and the hexafluoroacetone can be 0.9:1.2 to 1.2:0.9, or 1:1.2 to 1.2:1. In some aspects, the foregoing ratios refer to the initial stoichiometry used at the outset of polymerization, and subsequent additions of hexafluoroacetone may be included depending on reactivity and conversion, as further described in the working examples below. The polymerization can be conducted in a suitable organic solvent. The use of dichloroethane is specifically mentioned.

The polymerization is further conducted in the presence of an acid. In general, any suitable acid may be used. Acids that are generally used for direct electrophilic aromatic substitution reactions can include, for example, triflic acid, sulfuric acid, hydrochloric acid, phosphoric acid, fluorosulfonic acid, chlorosulfonic acid, methane sulfonic acid, and the like. In an aspect, the acid can comprise triflic acid. In some aspects, the corresponding anhydride can be used to generate the desired acid in situ. For example, triflic anhydride may be used to generate triflic acid.

The interfacial polymerization can further be conducted in the presence of a phase transfer catalyst. Any suitable phase transfer catalyst can be used, for example a quaternary ammonium salt. Exemplary quaternary ammonium salt phase transfer catalysts can include, but are not limited to, N-Methyl-N,N,N-trioctylammonium chloride. Other common quaternary ammonium salts can include, for example, tetrabutylammonium bromide, tetrabutylammonium chloride, benzyltriethylammonium chloride, tetramethylammonium chloride, and the like. Other phase transfer catalysts are also contemplated herein, for example phosphonium salts (e.g., tetraalkylphosphonium bromide), crown ethers, and polyethylene glycols. In some aspects, the quaternary ammonium salts may be preferred.

In some aspects, the hexafluoroacetone hydrate can be provided as an aqueous solution, for example having a concentration of at least 95% hexafluoroacetone hydrate.

The resulting polymer comprises a plurality of main chain 1,1,1,3,3,3-hexafluoroisopropylidene (6F) linkages. Stated another way, the polymer comprises a plurality of main chain linkages of the structure

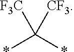 [SMILES: *C(*)(C(F)(F)F)C(F)(F)F]

In some aspects, the polymer can optionally further comprise pendant hexafluoro-i-propanol, or —C(CF₃)₂—OH (6FOH), groups formed along the main chain.

In some aspects, the resulting polymer can be a homopolymer, for example comprising repeating units having the structure

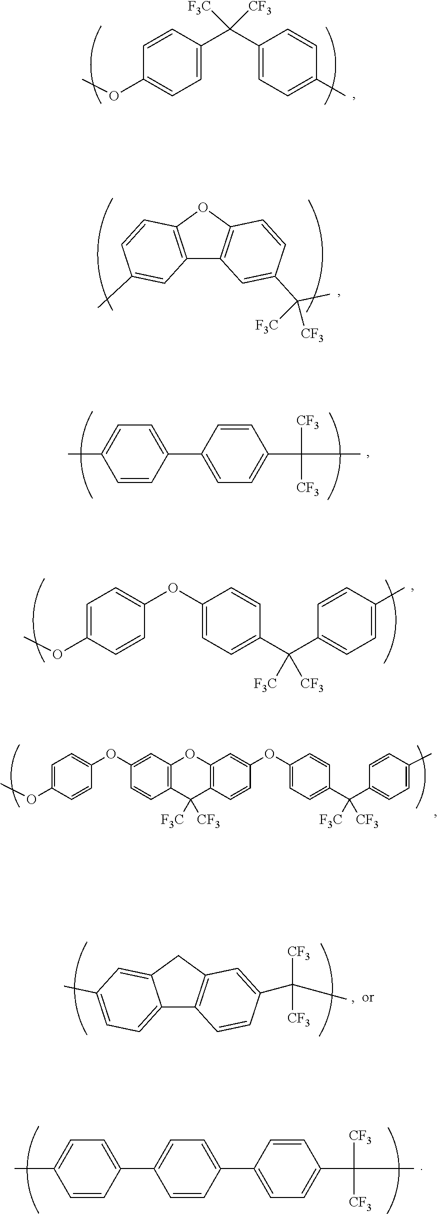

In some aspects, the method can further comprise contacting the hexafluoroacetone hydrate, the first aromatic monomer, and a second aromatic monomer in the presence of an acid to provide the polymer. When present, the second aromatic monomer is different from the first monomer. It will be further understood that additional aromatic monomers (e.g., a third aromatic monomer, a fourth aromatic monomer, etc.) can also be used, and that when present, each will be structurally distinct such that the resulting polymer is a copolymer. The copolymer can be a random copolymer, a segmented copolymer, a diblock copolymer, or a multi-block copolymer.

In a specific aspect, the second aromatic monomer can comprise diphenyl ether. In a specific aspect, the first aromatic monomer comprises biphenyl and the second aromatic monomer comprises diphenyl ether. The resulting polymer can be a random copolymer, a diblock copolymer or a triblock copolymer, for example comprising two blocks based on the biphenyl repeating unit, each adjacent to a central diphenyl ether block. In an aspect, the random copolymer can be of the structure

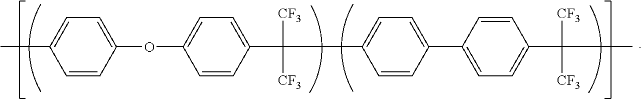

In an aspect, the polymer can be a triblock copolymer having the structure

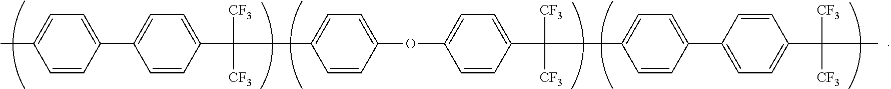

In some aspects, the polymer can be substantially linear. As used here, the term “substantially linear” refers to a polymer whose molecular chains are predominantly unbranched. Stated another way, the polymer can include monomer units that are connected end-to-end, within minimal to no branching off the main chain. In some aspects, the polymer can have a degree of branching that is less than 1 branch point per 100 monomer units, or wherein less than 0.5% of the total repeat units are branch points. In some aspects, the polymer is not crosslinked. In some aspects, the polymer can be soluble in a suitable organic solvent, such as dichloroethane or dichloromethane.

In some aspects, the first aromatic monomer can be derived from an activated aromatic polymer selected from a polyester, a polyphenylenesulfide, a polyphenylene oxide, a polyether ether ketone, a polyether ketone ketone, a polyimide, an ether-containing polyamide, an ether-containing polyimide, or an ether-containing polyester. For example, in some aspects, the first aromatic monomer can be in polymerized form, as part of a main chain polymer backbone of one of the aforementioned polymers. Stated another way, another aspect of the present disclosure is a method of making a polymer comprising main chain 1,1,1,3,3,3-hexafluoroisopropylidene (6F) linkages, the method comprising contacting hexafluoroacetone hydrate and an aromatic group-containing polymer in the presence of an acid to provide the polymer comprising main chain 1,1,1,3,3,3-hexafluoroisopropylidene (6F) linkages. In a specific aspect, the aromatic group-containing polymer can be a polyether ether ketone, and the method can be according to the reaction scheme

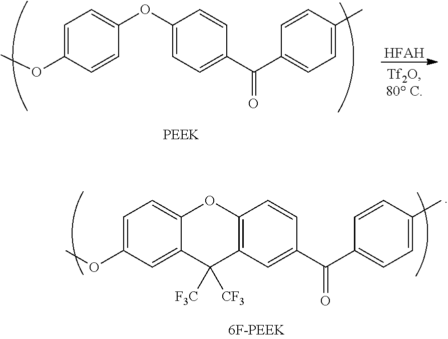

Another aspect of the present disclosure is a polymer comprising main chain 1,1,1,3,3,3-hexafluoroisopropylidene (6F) linkages, for example a polymer made by the method described herein. The polymer generally comprises repeating units of the structure

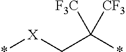

wherein X is derived from a first aromatic monomer having the structure

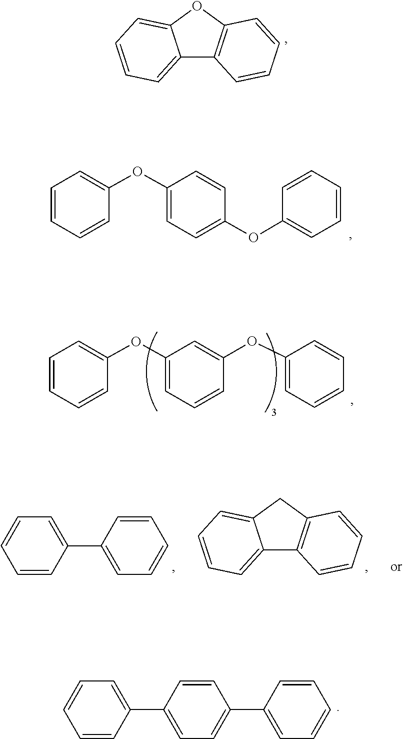

In some aspects, the polymer can optionally further comprise repeating units derived from one or more additional aromatic monomers to provide a copolymer. In a specific aspect, the polymer can be a copolymer further comprising repeating units wherein X is derived from diphenyl ether.

Advantageously, the method described herein can enable the preparation of a polymer comprising main chain 1,1,1,3,3,3-hexafluoroisopropylidene (6F) linkages that is substantially linear and not crosslinked. In some aspects, the polymer may have a weight average molecular weight of 10 kDa or more, and a dispersity of 1.5 to 3.5. The polymer can also have desirable thermal and optical properties. For example, the polymer can have a glass transition temperature Tg of 150 to 250° C. The polymer can have a transmittance of greater than 70% at at least one wavelength in the range of 350 to 800 nanometers when formed as a thin film (e.g., having a thickness of 0.01 to 0.05 millimeters).

In some aspects, the method can be adapted to provide a crosslinked polymer composition. In some aspects, the crosslinked polymer can comprise at least one-C(CF₃)₂—OH (6FOH) group.

In a specific aspect, the polymer can be a homopolymer having repeating units of the structure

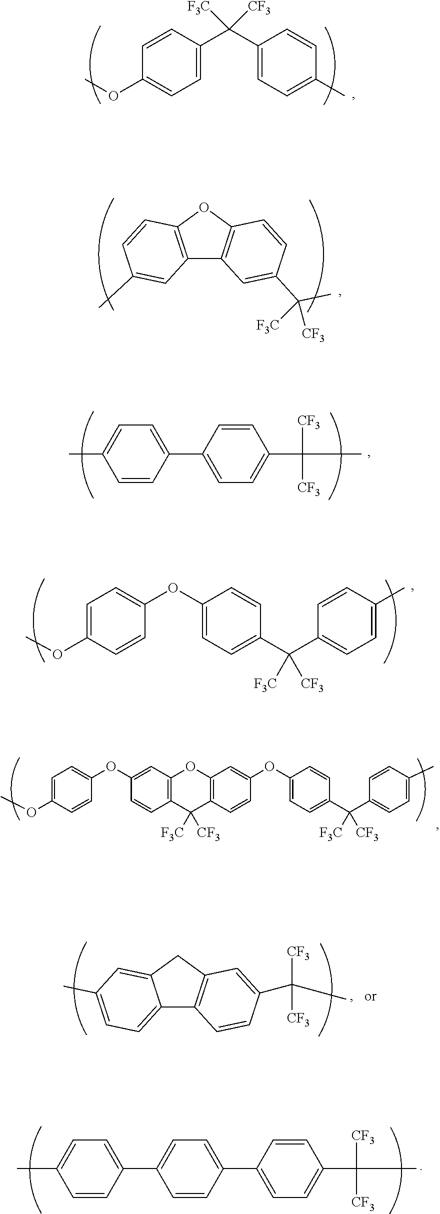

In another specific aspect, the polymer can be a random copolymer, for example having the structure

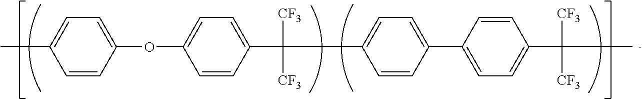

In yet another specific aspect, the polymer can be a triblock copolymer, for example having the structure

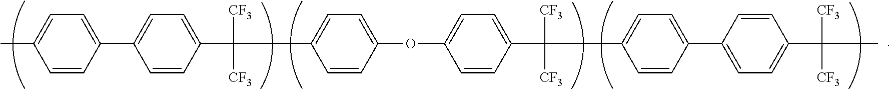

This disclosure is further illustrated by the following examples, which are non-limiting.

### Examples

### Experimental

### General Information

1,1,1,3,3,3-Hexafluoroacetone trihydrate (HFAH), trifluoromethanesulfonic anhydride (Tf₂O), dibenzofuran (M1), and 1,4-diphenoxybenzene (M2) were purchased from Oakwood Chemical. 1,3-Bis(3-phenoxyphenoxy)benzene (M3) was obtained from Santovac. Diphenyl sulfide, dibenzothiophene, thianthrene, and 1,2-dichloroethane (DCE) were supplied by Sigma Aldrich. Biphenyl (M4), fluorene (M5), p-terphenyl (M6), tetrahydrofuran (THF) (99.9%) and methanol (99.9%) were purchased from Fisher Chemical. N-Methyl-N,N,N-trioctylammonium chloride (Aliquat® 336) and diphenyl ether (DPE) were purchased from Thermo Scientific. All materials and reagents were used as received unless otherwise noted.

### Materials Characterization

Fourier-Transform Infrared (FTIR) spectra were collected using a Thermo Scientific Nicolet 6700 spectrophotometer with attenuated total reflectance (ATR) and a resolution of 2 cm⁻¹ in the region 4000-500 cm⁻¹. ¹H (500 MHz), ¹³C (125 Mhz), and ¹⁹F (470 MHz) NMR spectra were obtained in CDCl₃ using a Bruker Advance III NMR instrument. Differential scanning calorimetry (DSC) were obtained in nitrogen (50 mL/min) in a TA Instruments Q20 differential scanning calorimeter with a heating and cooling rate of 10° C./min. Thermogravimetric analysis (TGA) was performed under both nitrogen and air (50 mL/min) at a heating rate of 10° C./min from 40 to 1000° C. using a TA Instruments Q50 thermogravimetric analyzer. Molecular weights were measured by a gel permeation chromatography (GPC) ACQUITY Advanced Polymer chromatography system with an OMNISEC Reveal multi-detector. The sample solutions were prepared in THF (1-3 mg/mL) and filtered with 0.2-micron PTFE syringe filters. The samples were run with a THE flow of 1 mL/min at 35° C. Polystyrene standards were used for the universal calibration. Molecular weight was also determined by ¹⁹F-NMR end groups (—C(CF₃)₂OH) analysis. Given the slight excess of HFAH employed in the polymerizations, two-(CF₃)₂OH end groups per chain were assumed. However, it is noteworthy that the actual number of end groups might be greater due to the potential for multiple substitutions occurring on an internal aromatic ring.

### Polymerizations

### Synthesis of P1

168.2 mg (1.0 mmol) of M1, 264.1 mg (1.2 mmol) of HFAH, and 0.5 mL of DCE were added to a 35 mL pressure vessel equipped with Teflon™ bushing. The solution was stirred at room temperature for 5 min and then 10.0 mg (0.02 mmol) of phase transfer catalyst Aliquat® 336 was added, followed by the dropwise addition of 0.8 mL (5.0 mmol) of Tf₂O. The pressure vessel was sealed and heated at 60° C. with magnetic stirring for 24 h. The reaction mixture was cooled, precipitated in 100 mL methanol, filtered, dissolved in dichloromethane, and washed twice with saturated aqueous NaHCO₃. The organic fractions were dried with anhydrous Na₂SO₄, concentrated, and the polymer was precipitated again in methanol (100 mL). The product was filtered and vacuum dried (9.94 torr) overnight at 60° C. giving P1 as an off-white powder in 85% yield. IR ν=3088 (w; C—H), 1602 (s; C═C), 1577 (s; C═C), 1191 (b; C—O—C). ¹H NMR (500 MHz, CDCl₃, δ): 8.05 (s, 2H; Ar—H), 7.49 (s, J=8.00 Hz, 2H; Ar—H), 7.36 (d, J=8.00 Hz, 2H; Ar—H). ¹⁹F-NMR (470 MHz, CDCl₃, δ): −63.43 (s; —CF₃), −75.40 (s; —CF₃). Anal. Calcd for repeating unit C₁₅H₆OF₆: C, 56.97, H, 1.91; found: C, 57.13, H, 2.59.

The same procedure was used with monomers M2-M6 and copolymerization of diphenyl ether and biphenyl. Although monomer stoichiometry (1.0:1.2 eq.) was consistent at the start of each polymerization, in some cases subsequent additions of HFAH monomer were added depending on reactivity as, for example, in the case for P3 (vide infra). The yield and spectroscopy data for each polymer is presented below.

### Synthesis of P2

Yield of 75%. IR ν=3089 (w; C—H), 1608 (s; C═C), 1490 (s; C═C), 1235 (b; C—O—C). ¹H NMR (500 MHz, CDCl₃, δ): 7.34 (d, J=5.00 Hz, 4H; Ar—H), 7.08 (s, 4H; Ar—H), 6.95 (d, J=5.00 Hz, 4H; Ar—H). 13C NMR (125 MHz, CDCl₃, δ): 158.4 (C5), 152.1 (C8), 131.8 (C7), 127.5 (C1 and C4), 121.5 (C2 and C3), 119.5 (q, J_{C-F}=285 Hz, C9), 117.0 (C6), 63.5 (sep, J_{C-F}=25 Hz, C10). ¹⁹F-NMR (470 MHz, CDCl₃, δ): −64.05 (s; —C(CF₃)₂—), −75.15 (s; —(CF₃)₂OH).

### Synthesis of P3

Yield of 68%. IR ν=3068 (w; C—H), 1591 (s; C═C), 1245 (b; C—O—C). ¹H NMR (500 MHz, CDCl₃, δ): 6.67-7.7 (overlapped signals corresponding to Ar—H). ¹⁹F-NMR (470 MHz, CDCl₃, δ): −62.09 (s; —C(CF₃)₂-xanthene units), −64.07 (s; —C(CF₃)₂—), −75.75 (s; —(CF₃)₂OH).

### Synthesis of P4

Yield of 60%. IR ν=3046 (w; C—H), 1503 (s; C═C). ¹H NMR (500 MHz, CDCl₃, δ): 7.64 (d, J=10.00 Hz, 4H; Ar—H), 7.53 (d, J=10.00 Hz, 4H; Ar—H). 13C NMR (125 MHz, CDCl₃, δ): 140.5 (C4), 132.9 (C1), 130.8 (C3), 126.9 (C2), 126.6 (q, J_{C-F}=285 Hz, C6), 64.4 (sep, J_{C-F}=25 Hz, C5). ¹⁹F-NMR (470 MHz, CDCl₃, δ): −63.59 (s; —C(CF₃)₂—), −75.47 (s; —(CF₃)₂OH).

### Synthesis of P5

Yield of 65%. IR ν=3074 (w; C—H), 2920 (w; C—H), 1565 (s; C═C), 1512 (s; C═C). ¹H NMR (500 MHz, CDCl₃, δ): 7.80 (d, J=5.00 Hz, 2H; Ar—H), 7.61 (s, 2H; Ar—H), 7.46 (d, J=5.00 Hz, 2H; Ar—H). ¹⁹F-NMR (470 MHz, CDCl₃, δ): −63.34 (s; —C(CF₃)₂—), −75.47 (s; —(CF₃)₂OH).

### Synthesis of P6

Yield of 64%. IR ν=3036 (w; C—H), 1567 (s; C═C), 1512 (s; C═C). ¹H NMR (500 MHz, CDCl₃, δ): 7.73 (s, 4H; Ar—H), 7.68 (d, J=5.00 Hz, 4H; Ar—H), 7.55 (d, J=5.00 Hz, 4H; Ar—H). ¹⁹F-NMR (470 MHz, CDCl₃, δ): −63.56 (s; —C(CF₃)₂—), −75.51 (s; —(CF₃)₂OH).

### Synthesis of P7

Yield of 77%. IR ν=3050 (w; C—H), 1602 (s; C═C), 1566 (s; C═C), 1240 (b; C—O—C). ¹H NMR (500 MHz, CDCl₃, δ): 7.60 (d, J=5.00 Hz, 4H; Ar—H), 7.41 (s, 4H; Ar—H), 7.04 (d, J=5.00 Hz, 4H; Ar—H). ¹⁹F-NMR (470 MHz, CDCl₃, δ): −63.59 (s; —C(CF₃)₂—), −63.81 (s; —C (CF₃)₂—), −64.01 (s; —C(CF₃)₂—), −75.55 (s; —(CF₃)₂OH).

### Film Casting

Polymers P1-P7 (˜50 mg) were each dissolved in 2 mL of THF (HPLC grade). The films were cast in covered Petri dishes by evaporation over 24 h. The resulting films were peeled away from the dishes and dried in a vacuum (9.94 torr) for 24 h at 60° C.

### Transmittance and Extinction

The UV-vis extinction and transmittance spectra from 200 to 800 nm for the thin films were acquired using a Thermo Scientific Evolution 300 UV-vis spectrophotometer with a slit width of 2 nm and a scan rate of 120 nm/min. Blank spectra for each thin film were acquired without placing any material on the reference cell.

### Refractive Index and Dielectric Constant

Refractive indices for the films were performed at room temperature using a Reichert Abbe Mark III refractometer equipped with a reference wavelength of 589.3 nm (sodium D line). The dielectric constants were calculated using the Maxwell equation: n²=εᵣ, where n=refractive index and εᵣ=dielectric constant.

Results and Discussion

### Polymer Syntheses

The present inventors have previously demonstrated the triflic acid (TfOH) activation of the non-basic carbonyl group in hexafluoroacetone (HFA) to polymerize HFA with the activated aromatic monomer diphenyl ether. Hexafluoroacetone trihydrate (HFAH) was employed as a monomer. The water present in HFAH hydrolyzes the triflic anhydride (Tf₂O), yielding HFA and TfOH in situ (see FIG. 2). Due to the two strong electron-withdrawing groups (—CF₃) adjacent to the carbonyl, HFA requires superacid conditions to become reactive in electrophilic aromatic substitution (EAS). The protosolvation of HFA results in the formation of an unstable and highly electrophilic intermediate that initiates EAS reaction to give carbinol 1 (FIG. 2). Under high acidic interfacial conditions, 1 is protonated and dehydrated to produce intermediate cation 2, which reacts with a second aromatic monomer to propagate the polyhydroxyalkylation.

In 1966, Olah and Pittman (Stable Carbonium Ions. XXIV. Trifluoromethylcarbonium Ions, Protonated Trifluoromethyl Alcohols, and Protonated Fluoro Ketones, J Am Chem Soc. 88 (1966) 3310-3312) were unable to detect protonated HFA by NMR when hexafluoroacetone was dissolved in super acidic FSO3H/SbF5 at −60° C. That observation did not rule out an equilibrium to a small amount of protonated HFA in a rapid protonation/deprotonation equilibrium. In the same study, under identical conditions, protonation of a carbinol like 1 (α,α-bis(trifluoromethyl)benzyl alcohol) was observed, but there was no evidence that dehydration to the corresponding carbocation (like 2) had occurred unlike the case for aryl methyl trifluoromethyl carbinols. This indicated two electron-withdrawing —CF₃ groups greatly destabilized an adjacent carbocation center. Hence, carbocation formation in equilibrium with the protonated alcohol could only exist in this superacid in a very small amount if it did form. Subsequently, in 2013 computational studies by Fomine and collaborators predicted that proton solvation of HFA in TfOH occurs without complete proton transfer to the carbonyl group. A high activation energy to form a carbocation intermediate, like 2, was calculated. This finding suggests that the dehydration of carbinol 1 is the rate-determining step and raises doubts about the feasibility of this process for a polymerization approach. Nevertheless, the reaction of HFA with activated aromatic compounds has been used to produce bisphenol AF, fluorinated tetraphenols, and more recently our polymerization with diphenyl ether.

The addition of the phase transfer catalyst (PTC) Aliquat® 336 enables polymerization of DPE and HFAH via an interfacial process. The addition of PTC results in a significant increase in reaction rate and molecular weight thereby suggesting a direct and mild method to install 6F groups via interfacial electrophilic condensation polymerization. To test the scope of this approach, we next evaluated the method with other activated aromatic monomers M1-M3, as well as with non-activated monomers M4-M6 (FIG. 3). The structures of polymers P1-P6, yields, molecular weights, dispersities, and thermal properties are compiled in Table 1.

Polymerization of Activated Monomers with HFAH (P1-P3)

After the successful polymerization of diphenyl ether we considered other oxygen-containing monomers in which the lone electron pairs are conjugated with aromatic rings. These structures would stabilize the transition state and intermediate cyclohexadienyl cation leading to EAS. They would also stabilize intermediate 2 (FIG. 2) through resonance and enhance propagation. P1 was synthesized by polymerization of HFAH with planar and conjugated dibenzofuran (M1). From its 1H NMR spectrum, the product P1 showed a broad singlet at 7.36 ppm, a doublet around 7.49 ppm, and a singlet at 8.05 ppm. According to these signals dibenzofuran substitution occurred mainly in the 2 and 8 positions. The ¹⁹F-NMR spectrum demonstrated the presence of hexafluoroisopropilydene linkages at −63.4 ppm and some-C(CF₃)₂OH terminal groups at −75.4 ppm.

Using monomer 1,4-diphenoxybenzene (M2), polymer P2 was produced, which exhibited two broad doublets at 6.94 ppm and 7.34 ppm (J_{ab}=8.08 Hz) in its 1H-NMR spectrum. These signals correspond to the aromatic protons meta and ortho to the hexafluoroisopropylidene group, respectively. A singlet at 7.08 ppm was also observed for the center aromatic rings. These results reveal the high regioselectivity proceeding mainly via substitution at the para positions, thus forming a linear polymer. The structure of P2 was confirmed by ¹⁹F-NMR, with the presence of hexafluoroisopropylidene (6F) units at −64.0 ppm and a small terminal carbinol (—C(CF₃)₂OH) peak at −75.2 ppm.

The polymerization of 1,3-bis(3-phenoxyphenoxy)benzene (M3) produced a polymer with a surprising new structural feature not observed previously. The forest of aromatic 1H signals in the NMR spectrum of P3 are over lapped; however, in the ¹⁹F-NMR spectrum a signal at −64.1 ppm corresponding to the inter-chain 6F groups is observed with an additional broad signal around −66.6 ppm. This new fluorine signal is due to an intra-chain 6F linkage between two aromatic rings forming 9,9-hexafluorodimethylxanthene units in the polymer backbone. The area ratio of 6F groups forming xanthene and 6F groups linking the monomeric units was 1:1The end groups were observed at −75.7 ppm.

An optimal reaction time of 24 h was found for the synthesis of soluble P1-P3 with minimal branching. When polymerization of M1-M3 with HFAH exceeded 24 h, highly insoluble gels were observed due to increased branching and subsequent crosslinking.

TABLE 1

| | | Yield | Mₙ^{b} | Mₙ^{c} | | T_{g}^{d} | T_{d5%}^{e}(°C.) | |
|---|---|---|---|---|---|---|---|---|
| | Polymer^{a} | (%) | (kDa) | (kDa) | PDI | (° C.) | N₂ | air |
| P1 | 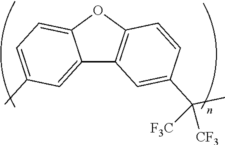 | 85 | 32.1 | 29.6 | 2.1 | 250 | 515 | 500 |
| P2 | 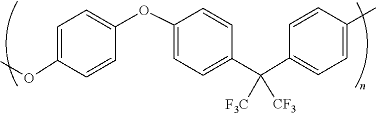 | 75 | 28.0 | 15.2 | 1.8 | 157 | 471 | 465 |
| P3 | 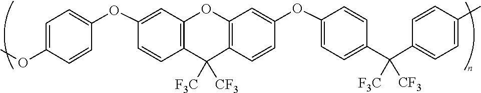 | 68 | 14.6 | 15.4 | 3.2 | 202 | 450 | 450 |
| P4 | 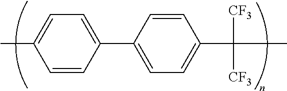 | 60 | 6.5 | 29.6 | 2.1 | 215 | 533 | 500 |
| P5 | 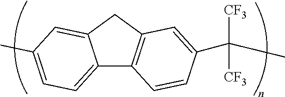 | 65 | 5.8 | 10.4 | 2.2 | 232 | 550 | 470 |
| P6 | 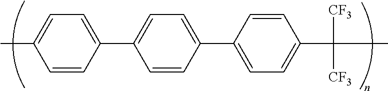 | 64 | 6.6 | 12.0 | 1.8 | 188 | 473 | 473 |
| P7 | 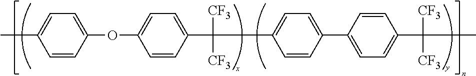 | 77 | 19.4 | 24.0 | 4.1 | 119 | 431 | 431 |

^{a}Terminated with —C(CF₃)₂OH end groups;
^{b}Determined by ¹⁹F-NMR end groups analysis;
^{c}Determined by GPC using universal calibration;
^{d}10° C./min in nitrogen, reproducible values for four cycles;
^{e}10° C./min in nitrogen and air.

Polymerization of Non-Activated Monomers with HFAH

Semi-fluorinated ketones such as 1,1,1-trifluoroacetone and trifluoroacetophenone have been successfully polymerized with non-activated aromatics such as biphenyl and terphenyl (see, e.g., A. M. Diaz, M. G. Zolotukhin, S. Fomine, R. Salcedo, O. Manero, G. Cedillo, V. M. Velasco, M. T. Guzman, D. Fritsch, A. F. Khalizov, A novel, one-pot synthesis of novel 3F, 5F, and 8F aromatic polymers, Macromol Rapid Commun. 28 (2007) 183-187; A. L. Rusanov, V. P. Chebotarev, S. S. Lovkov, Superelectrophiles in the synthesis of condensation monomers and polymers, Russian Chemical Reviews. 77 (2008) 547-553). The only previously reported method to obtain polymer P4 utilized a carbon-carbon coupling reaction of 2,2-bis(p-chlorophenyl) hexafluoropropane mediated by a nickel/zinc catalyst (FIG. 1a). Under the conditions depicted in FIG. 3, M4 (biphenyl) polymerized to form polymer P4. From the 1H-NMR spectrum of P4, two doublets at 7.53 ppm and 7.64 ppm (J_{ab}=10.0 Hz) corresponding to the aromatic proton signals were observed along with end group aromatic signals located around 7.82 ppm. The ¹⁹F-NMR spectrum exhibited the presence of 6F linkages at −63.59 ppm and end groups (—C(CF₃)₂OH) at −75.46 ppm, confirming primarily linear polymerization.

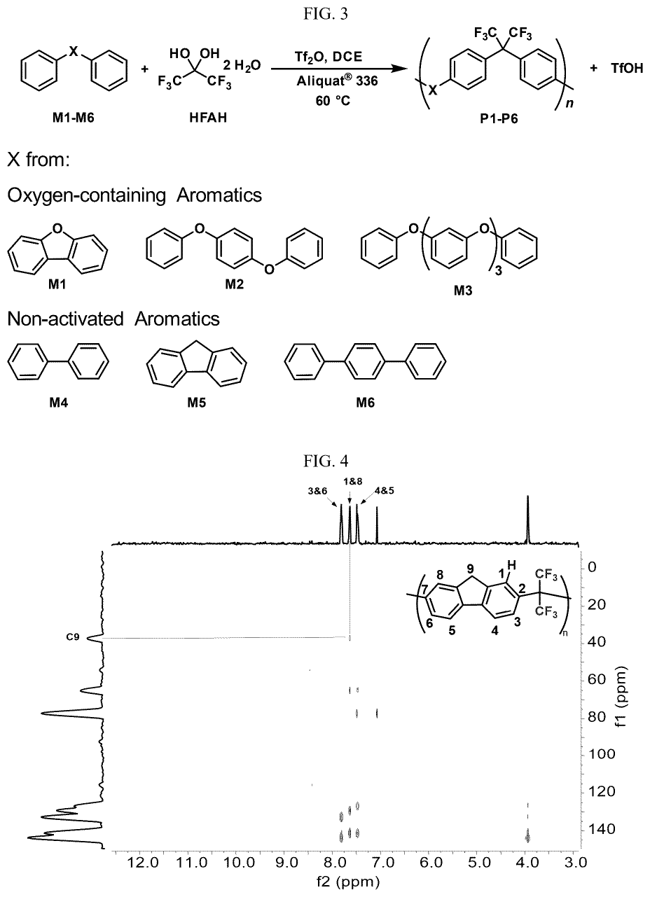

Fluorene (M5) polymerization to P5 was confirmed by two doublets at 7.46 and 7.80 ppm and one singlet at 7.61 ppm in the 1H-NMR spectrum. The 6F linkages were observed at −63.34 ppm in the ¹⁹F-NMR spectrum. The structure shown in Table 1 for P5 was confirmed by 2D-NMR. The coupling observed between aromatic protons at C1 and C8 with the sp3-hybridized carbon-C9 in the heteronuclear multiple bond correlation (HMBC) (FIG. 4) verified that regioselective substitution on positions 2 and 7 had occurred to form P5. p-Terphenyl (M6) produced low molecular weight P6.

In general, non-activated monomers M4-M6 gave lower molecular weight than activated monomers and a clear deviation from molecular weight agreement between NMR and GPC is evident (Table 1). The GPC values are understandably high due to the increased hydrodynamic volume for rigid rod-like structures and common overestimation of GPC Mn. The NMR determined values for Mn could likewise be lower than measured due to additional-C (CF₃)₂OH groups along the main chain with very similar chemical shifts as the actual terminal groups. Other results consistent with these observations include the unexplained tendency of the three non-activated monomers to give rapid gelation under standard conditions beyond the 24 hour polymerization time.

Copolymerization of Diphenyl Ether and Biphenyl with HFAH

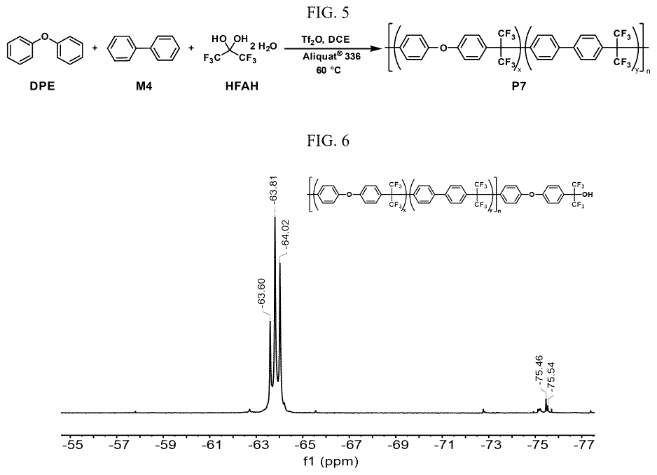

The copolymerization of diphenyl ether and biphenyl with HFAH was carried out (FIG. 5) under the same conditions used to prepare P1-P6. The ¹⁹F-NMR spectrum of P7 (FIG. 6) showed the end groups (—C(CF₃)₂OH) between −75.45 and −75.53 ppm. In addition, three different types of enchained hexafluoroisopropyl groups (6F) were observed; the signal at −64.01 ppm corresponds to the 6F linkages between two units of diphenyl ether (DPE). The peak at −63.59 ppm is located at the same chemical shift observed for P4 and corresponds to the 6F group between biphenyls (BP). Thus, we conclude that the signal at −63.81 ppm represented the 6F linkages between biphenyl and diphenyl ether. The ¹⁹F-NMR signals for the nearly random copolymer were deconvoluted and the resulting integrals provided a 21.3% BP-6F-BP, 44.4% BP-6F-DPE, and 34.2% DPE-6F-DPE linkage distribution compared to the statistical outcome (25:50:25%, respectively) for a random polymerization. The slight preference for DPE-6F-DPE homopolymerization is expected due to the activating ether linkage as described earlier.

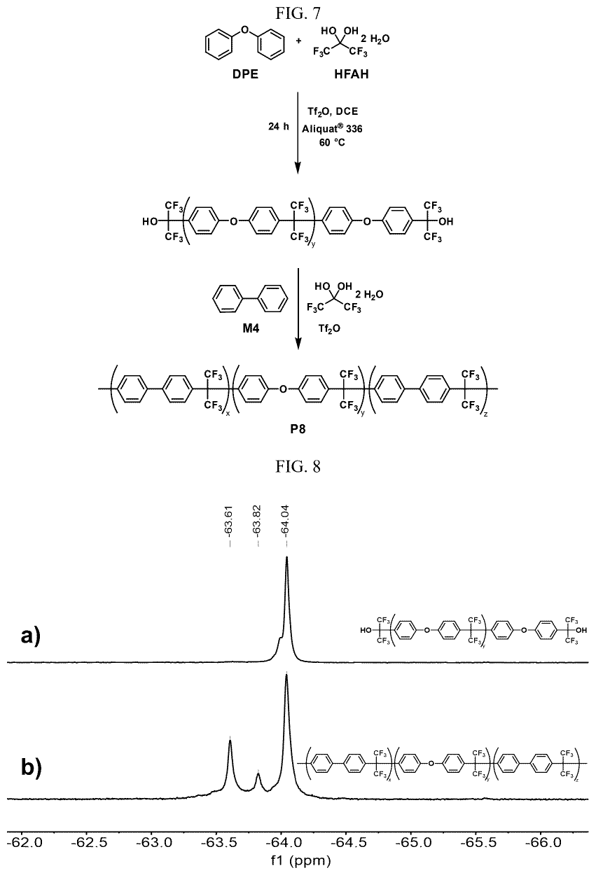

To test the versatility of our polymerization protocol to produce segmented or block copolymers, the homopolymerization of DPE and HFAH was carried out at 60° C. (ca. 24 h) until both monomers were consumed (FIG. 7). Main chain and end group 6F linkages were observed by ¹⁹F-NMR spectroscopy (FIG. 8a) and a molecular weight of 34.9 kDa was obtained by GPC. A second comonomer, biphenyl, was then added to the reaction mixture with a molar equivalent of HFAH (FIG. 7). After an additional 24 h, new 6F linkages were observed by ¹⁹F-NMR (FIG. 8b) which corresponded to the BP-6F-BP (−63.61 ppm) and BP-6F-DPE (−63.82 ppm) linkages. The resulting integrals provided a 28.1% BP-6F-BP, 13.2% BP-6F-DPE, and 58.7% DPE-6F-DPE linkage distribution. The low percentage of BP-6F-DPE units, when compared with the ¹⁹F-NMR for random copolymer in FIG. 6, is evidence of a segmented copolymer and possibly formation of a triblock copolymer. In the initial homopolymerization, a slight excess of HFAH was added. This generated the presence of two terminal groups (—C(CF₃)₂OH) in each chain. These end groups undergo EAS reactions with biphenyl in this second step to begin the generation of BP segments. After copolymerization the molecular weight of the final product was 44.4 kDa by GPC.

### Thermal Characterization of P1-P7

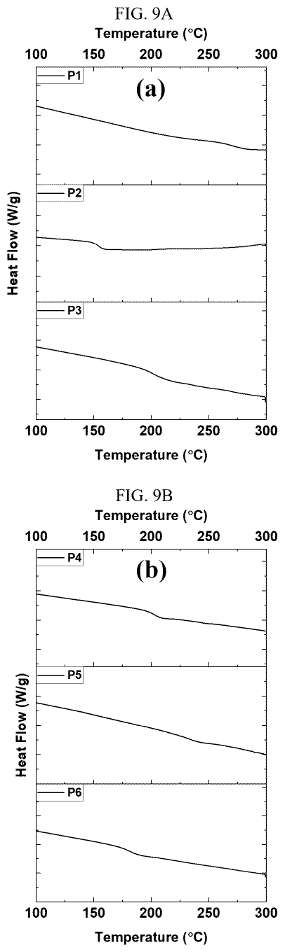

As shown in Table 1, DSC was used to determine the reproducible glass transition temperature (T_{g}) of 250° C. for P1, 157° C. for P2, and 202° C. for P3 (FIG. 9a). The high T_{g} of P1 results from the restricted mobility on the dibenzofuran units. This permits better interchain packing requiring more energy to break and activate segmental motion. While a T_{g} of 163° C. was measured for the polymer prepared from simple diphenyl ether and HFAH (FIG. 1b), removal of H2 and connecting the rings results in a remarkable 87° C. increase in T_{g}. The significantly lower T_{g} of P2 illustrates easier activation of segmental motion as the number of ether linkages between-C(CF₃)₂-groups increased. This was expected because the additional rotational freedom around C—O—C allowed more disorder between adjacent polymeric chains inducing more mobility at a lower temperature. Conversely, although P3 has a greater number of ether linkages per repeating unit, the xanthene units formed due to intramolecular condensation of every second incorporated hexafluoroacetone restricts the rotation of C—O—C bonds, increasing T_{g} to 202° C.

Polyphenylenes also exhibit high T_{g} values as shown in FIG. 9b. A T_{g} of 215° C. for P4 was observed, which is lower than that previously reported (255° C.). This difference could be associated with molecular weight or the influence of end groups where in our case the bulky-C(CF₃)₂OH terminal groups could increase free volume and decrease the intermolecular forces. This would decrease the T_{g} in comparison with the terminal —Cl in Sheares et al. work (Synthesis and Characterization of Poly [1,1′-biphenyl]-4,4′-diyl [2,2,2-trifluoro-1-(trifluoromethyl)ethylidene]], Macromolecules. 32 (1999) 6418-6424). A T_{g} of 232° C. was measured for polymer P5. The fluorene ring restricts rotation as observed for dibenzofuran in P1, allowing better polymer packing. We also note that the T_{g} of P5 is 17° C. higher than that of P4 thereby further demonstrating the restrictive influence of the bridging carbon in fluorene monomer. A T_{g} of 188° C. was obtained for P6.

The DSC of random copolymer P7 indicated a reproducible T_{g} of 119° C., presenting a surprisingly lower value than either of the corresponding homopolymers (163° C. for 6F-DPE and 215° C. for 6F-BP or P4). Although origins behind the divergence from predicted Fox theory remain elusive, it is associated with decreased interpolymer interactions in the copolymer and may help reveal subtle insights for the convoluted influence of the 6F group on T_{g} in polyarylenes with or without ether enchainment. A second undefined transition was observed above 250° C. On the other hand as expected, two distinct T_{g} values were observed for segmented copolymer P8 at 150° C. and 238° C. Although melting transitions were not observed for moderate molecular weight P1-P8, the semi-crystallinity of our initial high molecular weight 6F-DPE homopolymer may indicate that high polymer versions may order given the opportunity.

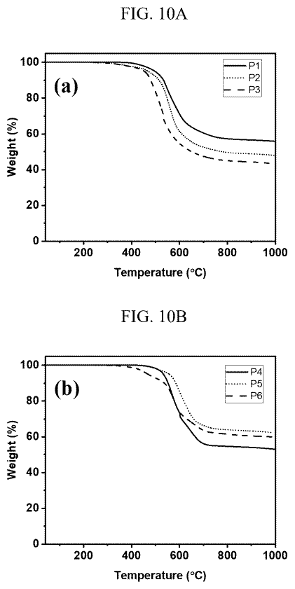

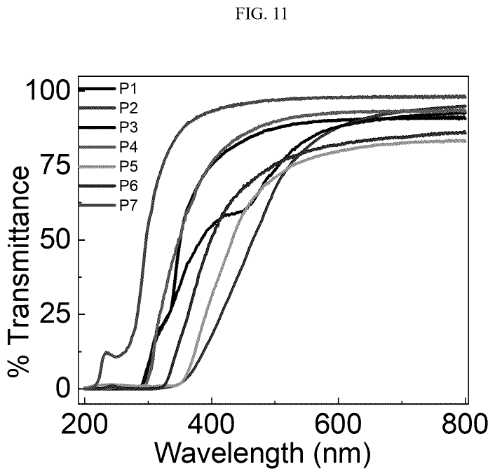

The TGA of P1 demonstrated outstanding thermal stability in both air and nitrogen. Thermal decomposition reached a 5% weight loss (T_{d5%}) at 515° C. under nitrogen (FIGS. 10a) and 500° C. in air. Similar stabilities were also observed in polyaryl ethers P2 and P3 as represented in FIG. 10a under nitrogen. The lower thermal stabilities of P2 and P3 stem from additional ether linkages per repeat unit. Thermal and thermal oxidative stability of P1-P3 are among the highest reported for semi-fluorinated polyaryl ethers approaching that of triphenylene-containing PFCB PAEs. Similar high T_{d5%} values have been previously reported for semi-fluorinated poly(ether ketones), which are well known semicrystalline high-performance materials.

TGA in nitrogen of polyphenylenes P4-P6 are shown in FIG. 10b; all Tas % values under air and nitrogen are reported in Table 1. TGA of P4 showed the slightly higher 5% weight loss (533° C.) than reported previously when this polymer was obtained via carbon-carbon coupling reactions (515° C.). For P5 and P6 T_{d5%} values of 550 and 473° C. were obtained, respectively. TGA of copolymer P7 showed a T_{d5%} of 410° C. and 420° C. in air and nitrogen, respectively.

### Transmittance of P1-P7

The transmittance of P1-P7 films were taken from 200 nm to 800 nm and shown in FIG. 11. Transmittance values >70% can be observed in the visible region for these polymeric materials. High transparency in the visible region is expected due to 6F group interruption of the conjugation between the aromatic moieties and the lone pair in the oxygen atoms.

### Refractive Index and Dielectric Constant

Fluorinated polymers are well known as low dielectric materials due to, primarily, the low polarizability of fluorine and the C—F bond. The large free volume that 6F demands also contributes. The refractive index (n) values for P1-P7 films were determined and Maxwell's equation was used to estimate the dielectric constants (ε) (Table 2). P1-P3 exhibited & values from 2.7905 to 2.8062. These oxygen-containing macromolecules values resemble other commercial fluorinated polymers like fluorinated polyimides (ε=2.5-2.9). In polyphenylenes P4-P6 where oxygen is absent, & values decreased to the range 2.3670-2.3247. Copolymer P7 exhibits a dielectric constant of 2.4236 showing again an increment in ε that could be associated to the ether linkages.

TABLE 2

| Sample | Temp. (° C.) | n^{a} | ε^{b} |
|---|---|---|---|
| P1 | 21.9 | 1.6752 | 2.8062 |
| P2 | 23.2 | 1.6773 | 2.8133 |
| P3 | 23.2 | 1.6705 | 2.7905 |
| P4 | 20.0 | 1.5385 | 2.3670 |
| P5 | 21.0 | 1.5427 | 2.3799 |
| P6 | 21.0 | 1.5247 | 2.3247 |
| P7 | 21.0 | 1.5568 | 2.4236 |
| PVDF^{c} | 24.8 | 1.4260 | 2.0335 |

^{a}At 589 nm;
^{b}Calculated using Maxwell's equation n = ε^{1/2};
^{c}n of 1.426 from literature.

### CONCLUSIONS

Successful interfacial electrophilic condensation polymerization of activated monomers dibenzofuran, 1,4-diphenoxybenzene, and 1,3-bis(3-phenoxyphenoxy)benzene (M1-M3) with hexafluoroacetone was accomplished. The present invention is the first report of hexafluoroacetone polymerization with non-activated aromatic monomers biphenyl, fluorene, and terphenyl (M4-M6). The polymers obtained presented low branching, high thermal stability to ˜500° C. under nitrogen, and glass transition temperatures ranging from 157° C. to 250° C. The polymerization of HFAH with monomers M1-M6 resulted in gelled products when the reaction time exceeded 24 h or when the temperature was higher than 140° C. Amorphous polymers P1-P6 exhibited high optical transparency in the visible spectrum and low dielectric constants. Random or segmented copolymerization of diphenyl ether and biphenyl with HFAH (P7 and P8) was demonstrated.

This disclosure further encompasses the following aspects.

Aspect 1: A method of making a polymer comprising main chain 1,1,1,3,3,3-hexafluoroisopropylidene (6F) linkages, the method comprising: contacting hexafluoroacetone hydrate and a first aromatic monomer in the presence of an acid to provide the polymer; wherein the first aromatic monomer has the structure

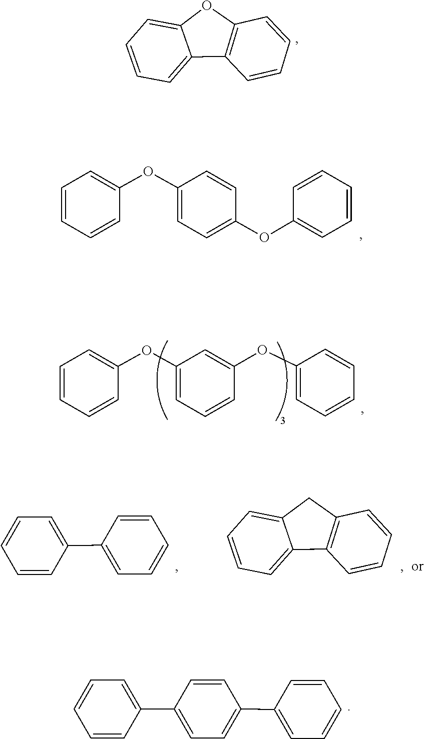

Aspect 2: The method of aspect 1, wherein the polymer comprising main chain 1,1,1,3,3,3-hexafluoroisopropylidene (6F) linkages comprises a plurality of repeating units having a main chain linkage of the structure

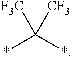

Aspect 3: The method of aspect 1 or 2, comprising contacting hexafluoroacetone hydrate, the first aromatic monomer, and a second aromatic monomer in the presence of an acid to provide the polymer, wherein the first aromatic monomer and the second aromatic monomer are different and the polymer is a copolymer.

Aspect 4: The method of aspect 3, wherein the second aromatic monomer comprises diphenyl ether.

Aspect 5: The method of aspect 3 or 4, wherein the polymer is a random copolymer.

Aspect 6: The method of aspect 3 or 4, wherein the polymer is a segmented copolymer, a diblock copolymer, or a multi-block copolymer.

Aspect 7: The method of any of aspects 3 to 6, wherein the first aromatic monomer, the second aromatic monomer, or both comprise one or more of a nitrogen atom, a sulfur atom, a phosphorous atom, a silicon atom, and a boron atom.

Aspect 8: The method of any of aspects 1 to 7, wherein the hexafluoroacetone hydrate is provided as an aqueous solution of 95% hexafluoroacetone hydrate.

Aspect 9: The method of any of aspects 1 to 8, wherein the acid is triflic acid.

Aspect 10: The method of aspect 9, wherein triflic anhydride is used to the generate triflic acid.

Aspect 11: The method of any of aspects 1 to 10, wherein the contacting is in the presence of a solvent and a phase transfer catalyst.

Aspect 12: The method of aspect 11, wherein the polymer is provided by interfacial polymerization.

Aspect 13: The method of aspect 11 or 12, wherein the phase transfer catalyst is quaternary ammonium salt phase transfer catalyst.

Aspect 14: The method of aspect 13, wherein quaternary ammonium salt phase transfer catalyst is N-Methyl-N,N,N-trioctylammonium chloride.

Aspect 15: The method of any of aspects 1 to 14, wherein the polymer is linear, not crosslinked, and soluble.

Aspect 16: The method of any of aspects 1 to 15, wherein the first aromatic monomer is derived from an activated aromatic polymer selected from a polyester, a polyphenylenesulfide, a polyphenylene oxide, a polyether ether ketone, a polyether ketone ketone, a polyimide, an ether-containing polyamide, an ether-containing polyimide, or an ether-containing polyester.

Aspect 17: The method of aspect 16, wherein pendant hexafluoro-i-propanol, orC(CF₃)₂—OH (6FOH), groups are formed along the main chain.

Aspect 18: A polymer prepared by the method of any of aspects 1 to 17.

Aspect 19: A polymer comprising main chain 1,1,1,3,3,3-hexafluoroisopropylidene (6F) linkages, wherein the polymer comprises repeating units of the structure

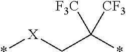

wherein X is derived from a first aromatic monomer having the structure

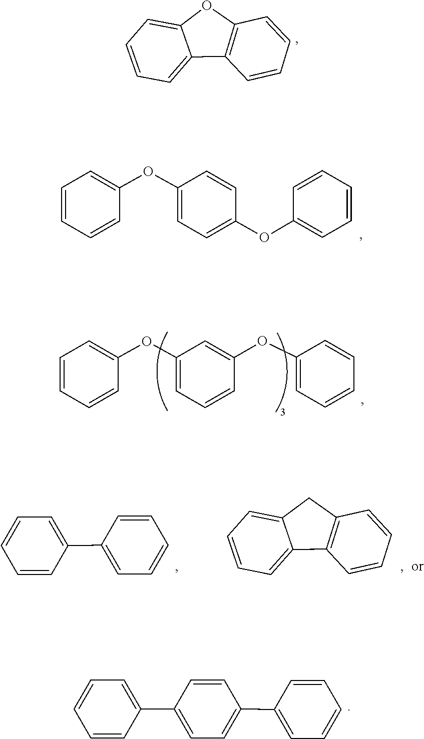

Aspect 20: The polymer of aspect 19, further comprising repeating units wherein X is derived from diphenyl ether.

Aspect 21: The polymer of aspect 19 or 20, wherein the polymer is linear and not crosslinked.

Aspect 22: The polymer of any of aspects 19 to 21, wherein the polymer has a weight average molecular weight of 10 kDa or more and a dispersity of 1.5 to 3.5.

Aspect 23: The polymer of any of aspects 19 to 22, wherein the polymer has a glass transition temperature Tg of 150 to 250° C.

Aspect 24: The polymer of any of aspects 19 to 23, wherein a film having a thickness of 0.01 to 0.05 millimeters and comprising the polymer has a transmittance of greater than 70% at at least one wavelength in the range of 350 to 800 nanometers.

Aspect 25: The polymer of aspect 19 or 20, wherein the polymer is a crosslinked polymer comprising at least one-C(CF₃)₂—OH (6FOH).

Aspect 26: The polymer of any of aspects 19 to 25, wherein the polymer comprises repeating units having the structure

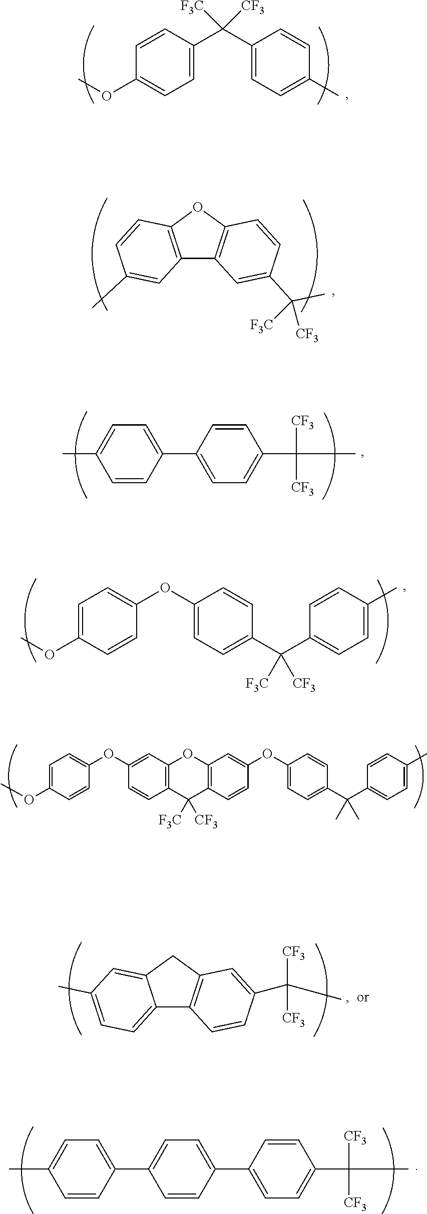

Aspect 27: The polymer of any of aspects 19 to 25, wherein the polymer is a random copolymer of the structure

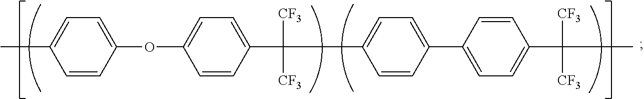

or a triblock copolymer of the structure

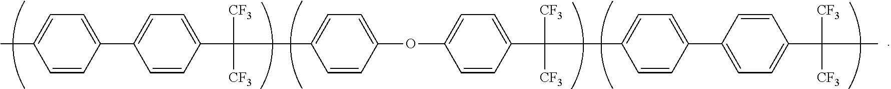

Aspect 28: A method of making a polymer comprising main chain 1,1,1,3,3,3-hexafluoroisopropylidene (6F) linkages, the method comprising: contacting hexafluoroacetone hydrate and an aromatic group-containing polymer in the presence of an acid to provide the polymer comprising main chain 1,1,1,3,3,3-hexafluoroisopropylidene (6F) linkages.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g, toluyl), C₄₋₁₂ heterocycloalkyl, C₃-12 heteroaryl, C₁₋₆ alkyl sulfonyl (—S(═O) 2-alkyl), C₆₋₁₂ arylsulfonyl (—S(═O) 2-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the compound or group, including those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of making a polymer comprising main chain 1,1,1,3,3,3-hexafluoroisopropylidene (6F) linkages, the method comprising:
contacting hexafluoroacetone hydrate and a first aromatic monomer in the presence of an acid to provide the polymer;
wherein the first aromatic monomer has the structure

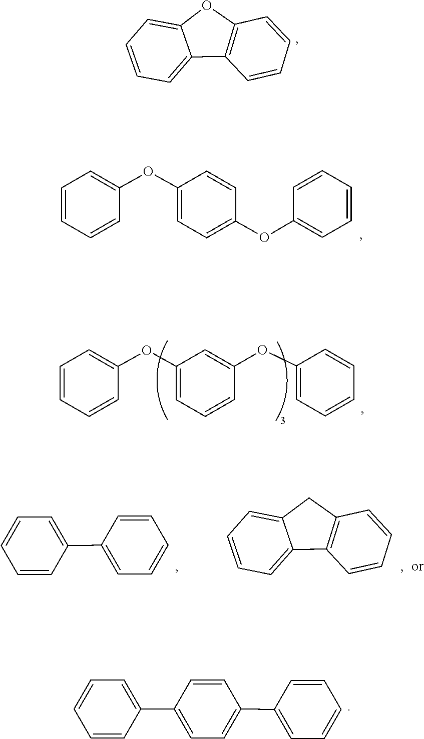

2. The method of claim 1, wherein the polymer comprising main chain 1,1,1,3,3,3-hexafluoroisopropylidene (6F) linkages comprises a plurality of repeating units having a main chain linkage of the structure

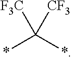

3. The method of claim 1, comprising contacting hexafluoroacetone hydrate, the first aromatic monomer, and a second aromatic monomer in the presence of an acid to provide the polymer, wherein the first aromatic monomer and the second aromatic monomer are different and the polymer is a copolymer.

4. The method of claim 3, wherein the second aromatic monomer comprises diphenyl ether.

5. The method of claim 3, wherein the polymer is a random copolymer, a segmented copolymer, a diblock copolymer, or a multi-block copolymer.

6. The method of claim 1, wherein the hexafluoroacetone hydrate is provided as an aqueous solution of 95% hexafluoroacetone hydrate.

7. The method of claim 1, wherein the acid is triflic acid, optionally wherein triflic anhydride is used to the generate triflic acid.

8. The method of claim 1, wherein the polymer is provided by interfacial polymerization and wherein the contacting is in the presence of a solvent and a phase transfer catalyst.

9. The method of claim 8, wherein the phase transfer catalyst is quaternary ammonium salt phase transfer catalyst.

10. The method of claim 1, wherein the polymer is linear, not crosslinked, and soluble in an organic solvent.

11. The method of claim 1, wherein pendant hexafluoro-i-propanol, or —C(CF₃)₂—OH (6FOH), groups are formed along the main chain.

12. A polymer prepared by the method of claim 1.

13. A polymer comprising main chain 1,1,1,3,3,3-hexafluoroisopropylidene (6F) linkages, wherein the polymer comprises repeating units of the structure 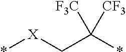
wherein X is derived from a first aromatic monomer having the structure

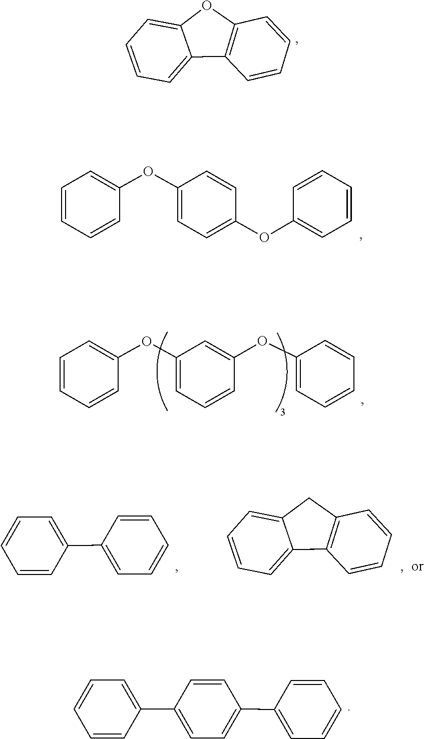

14. The polymer of claim 13, further comprising repeating units wherein X is derived from diphenyl ether.

15. The polymer of claim 13, wherein the polymer is linear and not crosslinked.

16. The polymer of claim 13, wherein
the polymer has a weight average molecular weight of 10 kDa or more and a dispersity of 1.5 to 3.5;
the polymer has a glass transition temperature T_{g} of 150 to 250° C.; or
a film having a thickness of 0.01 to 0.05 millimeters and comprising the polymer has a transmittance of greater than 70% at at least one wavelength in the range of 350 to 800 nanometers.

17. The polymer of claim 13, wherein the polymer is a crosslinked polymer comprising at least one-C(CF₃)₂—OH (6FOH).

18. The polymer of claim 13, wherein the polymer comprises repeating units having the structure

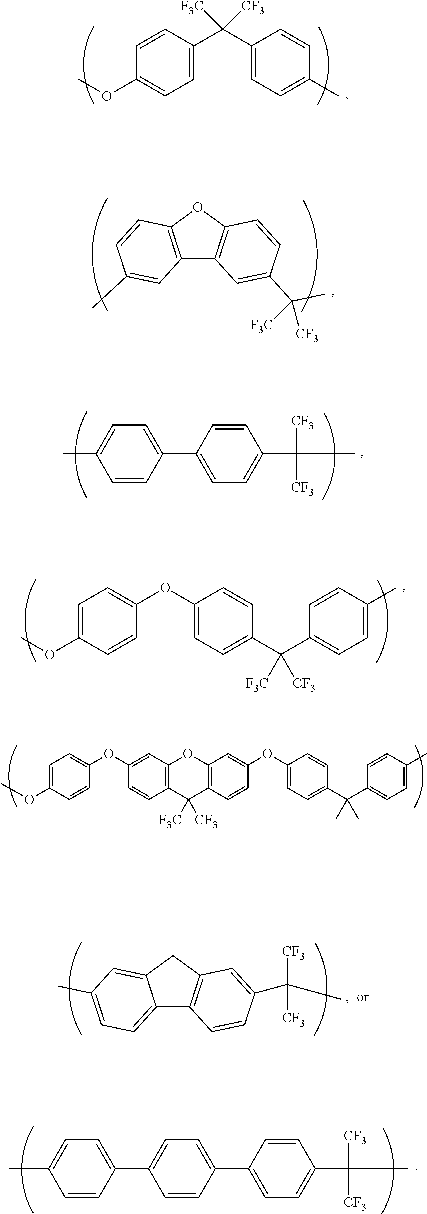

19. The polymer of claim 13, wherein the polymer is
a random copolymer of the structure 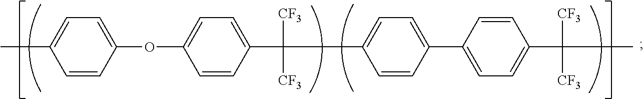
or
a triblock copolymer of the structure

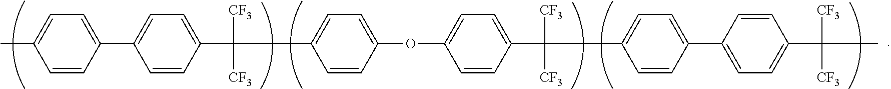

20. A method of making a polymer comprising main chain 1,1,1,3,3,3-hexafluoroisopropylidene (6F) linkages, the method comprising:
contacting hexafluoroacetone hydrate and an aromatic group-containing polymer in the presence of an acid to provide the polymer comprising main chain 1,1,1,3,3,3-hexafluoroisopropylidene (6F) linkages.
